(19) United States
(12) Patent Application Publication
(10) Pub. No.: US 2019/0305684 A1
(43) Pub. Date: Oct. 3, 2019

(54) Apparatus for Power Converter with Improved Performance and Associated Methods

(71) Applicant: Silicon Laboratories Inc., Austin, TX (US)

(72) Inventor: Jeffrey L. Sonntag, Austin, TX (US)

(21) Appl. No.: 15/939,195

(22) Filed: Mar. 28, 2018

(51) Int. Cl. H02M 3/158

(52) U.S. Cl. CPC H02M 3/1582; H02M 2001/0045

(57) ABSTRACT

An apparatus includes a voltage converter to convert an input voltage to an output voltage. The voltage converter includes an inductor. The voltage converter further includes a controller to control a current flowing through the inductor using a peak inductor-current derived from the input voltage of the voltage converter.

### TECHNICAL FIELD

The disclosure relates generally to electronic circuitry and, more particularly, to apparatus for power converters with improved performance characteristics, and associated methods.

### BACKGROUND

With advances in technology, an increasing number of circuit elements have been integrated into devices, such as integrated circuits (ICs). Furthermore, a growing number of devices, such as ICs, or subsystems, have been integrated into products. With developments such as the Internet of Things (IoT), this trend is expected to continue.

The growing number of circuit elements, devices, subsystems, etc., has also resulted in a corresponding increase in the amount of power consumed in the products that include such components. In some applications, such as battery powered, mobile, or portable products, a limited amount of power or energy is available. Given the relatively small amount of power or energy available in such applications, reduced power consumption of the components or products provides advantages or benefits, for example, extending the battery life, increasing the “up-time” or active time of the system, and the like. Even in non-portable environment, increased power consumption invariably results in larger amounts of generated heat, as the electrical energy is not used 100% efficiently. Thus, reduced power consumption of the components or products provides advantages or benefits, for example, reduced heat amounts, reduced cost of electricity, and the like.

Because of a mismatch between a typical supply or input voltage (e.g., battery voltage) and the desired supply voltage for loads, often voltage converters are used to supply power to loads. More specifically, one or more voltage converters are used to convert the input voltage to either a higher or a lower voltage that is suitable for supplying power to various loads.

The description in this section and any corresponding figure(s) are included as background information materials. The materials in this section should not be considered as an admission that such materials constitute prior art to the present patent application.

### SUMMARY

A variety of apparatus and associated methods are contemplated according to exemplary embodiments. According to one exemplary embodiment, an apparatus includes a voltage converter to convert an input voltage to an output voltage. The voltage converter includes an inductor. The voltage converter further includes a controller to control a current flowing through the inductor using a peak inductor-current derived from the input voltage of the voltage converter.

According to another exemplary embodiment, an IC includes a voltage converter operating in a boost mode to convert an input voltage to an output voltage that is higher than the input voltage. The voltage converter includes an inductor coupled to a set of switches, and a controller to control the set of switches using pulse-frequency modulation (PFM) such that the peak inductor-current substantially equals a value derived from the input voltage of the voltage converter.

According to another exemplary embodiment, a method of operating a voltage converter includes deriving a peak-current value from an input voltage of the voltage converter. The method further includes controlling a set of switches in the voltage converter to repetitively charge an inductor in the voltage converter to the derived peak-current value.

### BRIEF DESCRIPTION OF THE DRAWINGS

The appended drawings illustrate only exemplary embodiments and therefore should not be considered as limiting the scope of the application or the claims. Persons of ordinary skill in the art will appreciate that the disclosed concepts lend themselves to other equally effective embodiments. In the drawings, the same numeral designators used in more than one drawing denote the same, similar, or equivalent functionality, components, or blocks.

FIG. 1 shows waveforms associated with a conventional voltage converter.

FIG. 2 shows a boost voltage converter according to an exemplary embodiment.

FIG. 3 shows a buck-boost voltage converter according to an exemplary embodiment.

FIG. 4 shows a circuit arrangement for an IC that includes a voltage converter according to an exemplary embodiment.

FIG. 5 shows a circuit arrangement for an IC that includes a voltage converter according to another exemplary embodiment.

FIG. 6 shows a circuit arrangement for an IC that includes a voltage converter according to another exemplary embodiment.

FIG. 7 shows a circuit arrangement for an IC that includes a voltage converter according to another exemplary embodiment.

FIG. 8 shows a circuit arrangement including a controller for a voltage converter according to an exemplary embodiment.

FIG. 9 shows a circuit arrangement including a controller for a voltage converter according to another exemplary embodiment.

FIG. 10 shows a circuit arrangement for an IC, including a voltage converter, according to an exemplary embodiment.

### DETAILED DESCRIPTION

The disclosed concepts relate generally to electronic circuitry and, more particularly, to apparatus for electronic power converters with improved performance characteristics, and associated methods. The power or voltage converters may be used in a variety of applications, such as in portable or mobile electronic equipment or in electronic equipment that receive power from a source such as a battery (or super-capacitor).

A variety of schemes have been used conventionally to control DC-DC converters (e.g., voltage converters that convert a DC input voltage from a battery to a suitable DC output voltage for a load, such as an IC). In a widely used scheme, the duty-cycle of the waveforms controlling one or more switches in the converter is changed in response to changes such as the input voltage, the output current, etc. In this scheme, in various phases of operation, switches in the converter are enabled to cause the current in the inductor to increase or decrease.

Another control scheme used in DC-DC converters is pulse-frequency modulation (PFM). In such converters, PFM is used to alternately charge an inductor and deliver the energy stored in the inductor to the load, then wait until additional energy is demanded at the load. In other words, the inductor is charged during each PFM pulse, and subsequently the energy stored in the inductor is used to deliver a charge to the load.

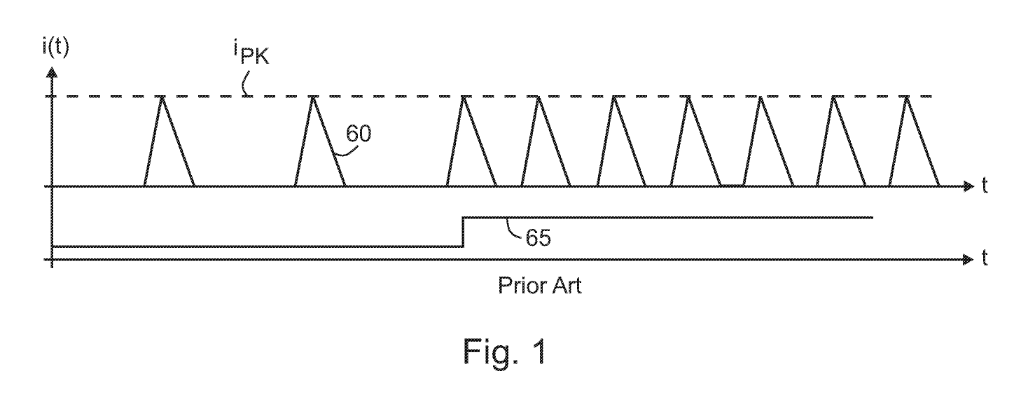

FIG. 1 shows waveforms associated with a conventional voltage converter that uses PFM. Waveform 60 illustrates the current pulses in the inductor in the converter. Note that in the example shown the pulses have a finite time period separating them from one another. Assuming that the pulses have a relatively uniform shape, the time period between the pulses can vary according to the load current.

Waveform 65 shows the output or load current, i.e., the current that the converter delivers to a load. In response to a step-change in the load current, the frequency of pulses of inductor current increases. In other words, assuming again inductor-current pulses of a uniform shape, the change in the load current causes the frequency of the inductor-current pulses to increase.

As noted above, the inductor is alternately charged and discharged in order to deliver power to the load. As the load current increases, the frequency of the inductor current pulses increases to meet the load's demand for more current, denoted as the step change in waveform 65. Note that the peak inductor current, i_{PK}, is constant as the pulse-frequency changes.

The peak inductor-current influences various characteristics of the converter. More specifically, the frequency of operation of the converter is inversely proportional to the square of the peak inductor-current. Thus, the amount of power dissipated in driving the switches used in the converter depends on the value of the peak inductor-current. Too-small values of the peak inductor-current result in relatively low conversion-efficiency because of the relatively high pulse frequency (to compensate for the relatively low peak inductor-current, which determines the amount of current delivered to the load).

The peak inductor-current also influences the resistive losses in the converter's switches. More specifically, the resistive losses are proportional to the square of the peak inductor-current. Thus, too-large values of the peak inductor-current also cause relatively low conversion efficiency.

Furthermore, the peak inductor-current determines the maximum load-current that the converter can supply while still regulating the output voltage. In a PFM-controlled converter, the maximum load current that the converter can deliver depends on the converter topology or mode of operation.

Assuming the approximation that the minimum time between successive inductor-current pulses is zero, for a converter operating in boost mode, the maximum load current, i_{loadmax}, is given by:

$${I}_{load max} = \frac{{i}_{PK}}{2} \cdot \frac{{V}_{in}}{{V}_{out}} ,$$

where Vᵢₙ and Vₒᵤₜ denote, respectively, the input voltage (e.g., the voltage of a battery providing power to the converter) and the output voltage (e.g., the voltage delivered to a load) of the converter. For a buck-boost converter operating in the buck mode, the maximum load current is given by:

$${I}_{load max} > \frac{{i}_{PK}}{2} .$$

Thus, for a converter operating in the boost mode, to provide a given maximum load-current, the peak inductor-current value might have to be increased by a relatively large amount (compared to the buck mode of operation), the ratio between the output voltage and the input voltage of the converter, i.e., Vₒᵤₜ/Vᵢₙ.

When the converter is used in a typical configuration and operating in the boost mode, the input voltage (e.g., from a battery having a finite internal resistance that changes over time) can vary by relatively large amounts. More specifically, the input voltage is relatively high if the battery is fully charged or fresh, and depending on the battery technology (and possibly environmental factors, such as temperature) drops to a lower value, perhaps 50% of the original voltage, before the battery is completely discharged.

Assuming a fixed peak inductor-current, the change in the input voltage affects the maximum load-current that the converter can deliver to the load. Thus, in the example above, the maximum load-current drops by relatively large amounts (perhaps factor of 2) as the battery approaches a discharge state and the input voltage decreases.

To avoid the relatively large maximum load-current variation, one might use a relatively large value of the peak inductor-current such that, even with the lowest value of the input voltage, sufficient load current may be supplied. Doing so, however, results in additional losses and lower efficiency. As an alternative, a variable peak inductor-current may be used that changes in response to the load current. Such a converter would exhibit some delay in shifting to a higher value of the peak inductor-current when the load current increases. During the delay period, the output voltage would fall because of the yet-unchanged relatively low value of the peak inductor-current.

In various embodiments, DC-DC switch-mode voltage converters, using PFM, with a new control technique are contemplated that use a desired value of the peak inductor-current. More specifically, the voltage converters, operating in the boost mode, use a value of the peak inductor-current (i_{PK}) that is derived from, or is a function of, the input voltage (Vᵢₙ) of the converter. Thus, values of the peak inductor-current are derived and used to control the switches of the voltage converter, such that the actual peak inductor-current is equal (or approximately or substantially equal, in a practical, physical implementation) to the derived peak inductor-current.

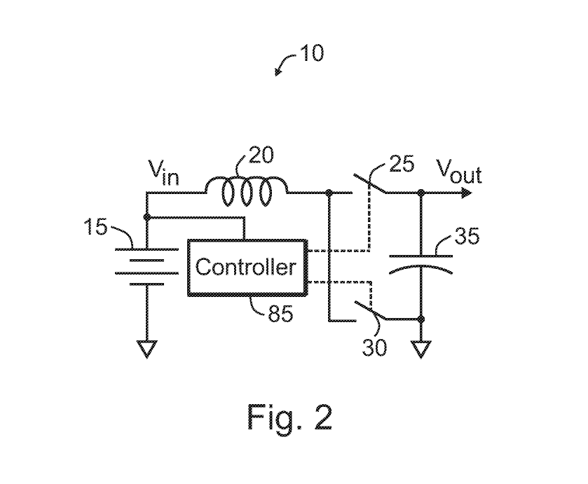

FIG. 2 shows a circuit arrangement 10 for a DC-DC switch-mode boost voltage converter according to an exemplary embodiment. In the embodiment shown, the voltage converter includes inductor 20, switch 25, switch 30, controller 85, and capacitor 35.

Switches 25 and 30 open and close under the control of controller 85. In various embodiments, switches 25 and 30 constitute transistors. In some embodiments, switches 25 and 30 constitute metal oxide semiconductor field-effect transistors (MOSFETs). In some embodiments, switches 25 and 30 constitute bipolar junction-transistors (BJTs) or insulated-gate bipolar transistors (IGBTs). Other types of switch are contemplated and may be used, as persons of ordinary skill in the art will understand.

To control the switches, controller 85 provides current or voltage control signals (depending on the type of transistor used) to switches 25 and 35. To charge the inductor, controller 85 causes switch 30 to close and switch 25 to open. As a result, current flows from input source 15 (a battery in the example shown) through the inductor, and a magnetic field builds up.

To deliver current to the load (not shown, but coupled to the output node, i.e., the node labeled “Vₒᵤₜ”), controller 85 causes switch 30 to open, and switch 25 to close. As a result, current flows through the inductor to the load. The current charges capacitor 35. Capacitor 35 reduces the output ripple-voltage of the converter, and also provides current to the load between PFM pulses and during the inductor charging phase.

To control switches 25 and 30, controller 85 uses PFM. Furthermore, as noted above, controller 85 uses a level of the peak inductor-current (i_{PK}) that is derived from, or is a function of, the input voltage (Vᵢₙ) of the converter.

In some embodiments, the value of the peak inductor-current given by:

$${i}_{PK} = 2 {i}_{load max} \cdot \frac{{V}_{out}}{{V}_{in}}$$

is used. In some embodiments, an approximation of the value of the peak inductor-current given by the above formula is used. For example, in some embodiments, the value of the peak inductor-current given by:

$${i}_{PK} ∝ \frac{1}{{V}_{i n}}$$

is used. In other words, a peak inductor-current that is proportional to the inverse of the input voltage of the converter is used to control the switches in the voltage converter, as described above.

Note that the exact values of the peak inductor-current given by the above equations cannot be used in a practical, physical implementation. The reasons include process, voltage, and temperature (PVT) effects or variations, component non-idealities, etc., as persons of ordinary skill in the art will understand. In particular, the formulae provided do not take into account losses due to switch and inductor parasitic resistances. When those factors are considered, a somewhat larger level of i_{PK} may be used to provide a given or desired value of i_{loadmax}. In addition, any residual error should be positive (more current available than is needed in the worst case). Thus, in practical implementations, an approximation of the values given by the above equations are used, or the actual peak inductor-current is slightly larger (in a practical, physical implementation) than the peak inductor-current value given by the above equations.

Examples include values of the peak inductor-current that are substantially or approximately equal to the ideal values given by the above equations. The deviation from the values prescribed by the above equations accounts for non-idealities in a practical, physical implementation, as noted above. A value of i_{PK} which is 15-25% higher than indicated by the above formulae is likely to be sufficient (to ensure that available maximum load current always exceeds the requirement) in a well-designed implementation. A more conservative implementation would still benefit from an efficiency level higher than would be obtained using a fixed value of i_{PK} while using a value of i_{PK} that is (for some voltages) as much as 50% higher than that indicated by the previous formulae.

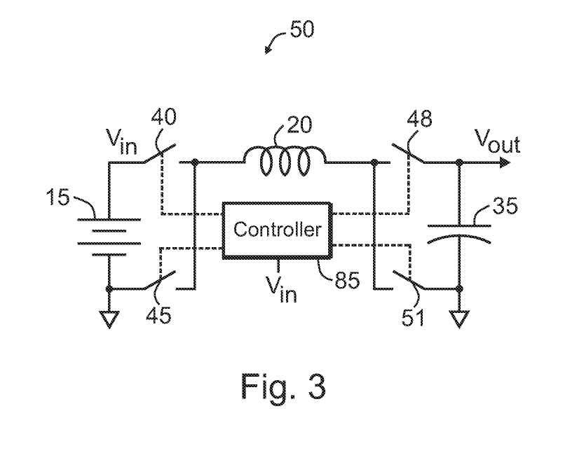

Similar techniques may be applied to advantageously control the operation of a DC-DC switch-mode buck-boost converter. FIG. 3 shows a circuit arrangement 50 for a switch-mode DC-DC buck-boost voltage converter according to an exemplary embodiment. In the embodiment shown, the voltage converter includes inductor 20, switch 40, switch 45, switch 48, switch 51, controller 85, and capacitor 35.

Switches 40, 45, 48, and 51 open and close under the control of controller 85. In various embodiments, switches 40, 45, 48, and 51 constitute transistors. In some embodiments, switches 40, 45, 48, and 51 constitute MOSFETs. In some embodiments, switches 40, 45, 48, and 51 constitute BJTs. Other types of switch are contemplated and may be used, as persons of ordinary skill in the art will understand.

To control the switches, controller 85 provides current or voltage control signals (depending on the type of transistor used) to switches 40, 45, 48, and 51, similar to the boost converter described above. Capacitor 35 performs the functionality noted above.

To control switches 40, 45, 48, and 51, controller 85 uses PFM. Furthermore, as noted above, in the boost mode of the buck-boost converter, controller 85 uses a level of the peak inductor-current (i_{PK}) that is derived from, or is a function of, the input voltage (Vᵢₙ) of the converter. Thus, in various embodiments, values of the peak inductor-current described above in connection with the boost converter of FIG. 2 may be used.

DC-DC switch-mode voltage converters according to various embodiments, such as the exemplary embodiments described above, provide improved converter characteristics, such as a fixed rated maximum load current even as the input voltage of the voltage converter varies or drops. Furthermore, voltage converters according to various embodiments provide improved power conversion efficiency as the input voltage varies. In addition, voltage converters according to various embodiments provide improved transient characteristics when the load current is increased in a relatively short period of time.

DC-DC switch-mode converters according to various embodiments may be used in a variety of apparatus. Examples include systems, sub-systems, blocks, electronic circuits, ICs, multi-chip modules (MCMs), thin-film circuits, thick-film circuits, etc., as persons of ordinary skill in the art will understand.

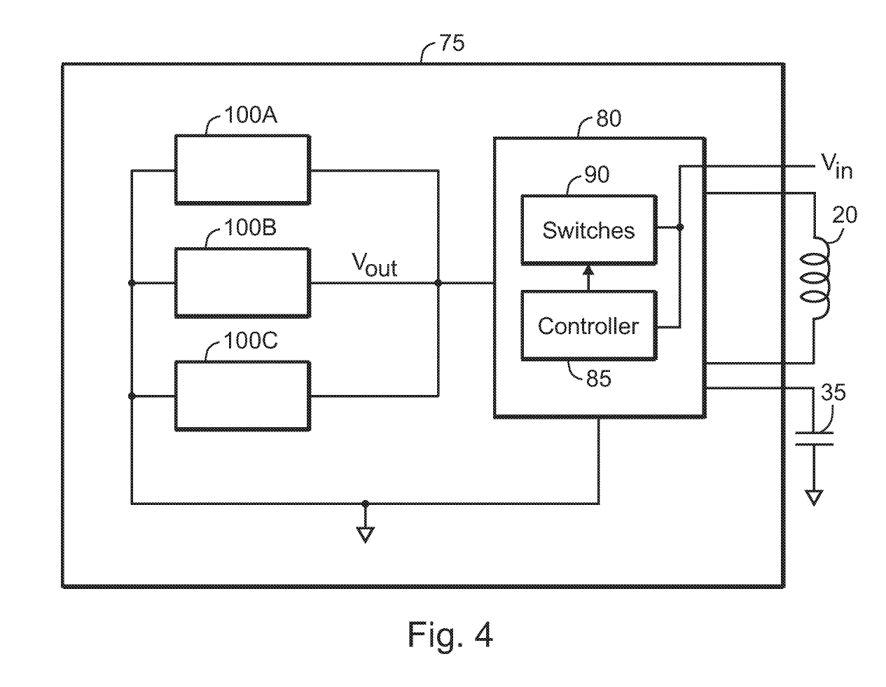

Without limitation, FIGS. 4-7 provide examples of DC-DC switch-mode converters used in ICs. FIG. 4 shows a circuit arrangement for an IC 75 that includes a voltage converter 80 according to an exemplary embodiment. In various embodiments, voltage converter 80 may constitute one of the voltage converters shown in FIGS. 2-3, described above. Referring again to FIG. 4, voltage converter 80 includes controller 85, which controls a set of switches 90. Switches 90 may include a number of switches, such as switches 25 and 30 (see FIG. 1) or switches 40, 45, 48, and 51 (see FIG. 3), depending on the choice of topology of voltage converter 80.

Referring again to FIG. 4, controller 85 controls switches 90 using the techniques described above. In other words, when voltage converter 80 is operating in the boost mode, controller 85 uses a level of the peak inductor-current (i_{PK}) that is derived from, or is a function of, the input voltage (Vᵢₙ) of voltage converter 80.

In various embodiments, voltage converter 80 produces one or more output voltages. In the exemplary embodiment shown, voltage converter 80 produces output voltage Vₒᵤₜ. Output voltage Vₒᵤₜ is provided to one or more loads. In the exemplary embodiment shown, voltage converter 80 provides the output voltage Vₒᵤₜ to a set of three loads although, as persons of ordinary skill in the art will understand, different numbers of loads, such as a single load, two loads, or more than three loads may be used, as desired.

Referring again to FIG. 4, the set of loads includes load 100A, load 100B, and load 100C. In various embodiments, load 100A may constitute (or include) analog circuitry, load 100B may constitute digital circuitry, and load 100C may constitute mixed-signal circuitry. As persons of ordinary skill in the art will understand, however, different configurations and/or types of load may be used in various embodiments. For instance, in some embodiments, load 100A may be used, and loads 100B-100C may be absent. As another example, in some embodiments, load 100B may be used, while loads 100A and 100C may be absent. As another example, in some embodiments, load 100C may be used, and loads 100A-100B may be absent. As yet another example, in some embodiments, loads 100A and 100B may be used, while load 100C may be absent.

As described above, voltage converters according to various embodiments include at least one inductor (shown as inductor 20) and at least one capacitor (shown as capacitor 35, although capacitor 35 may be omitted if the output ripple voltage is tolerable, stability does not pose a concern for voltage converter 80, and/or one or more loads include sufficient capacitance). A variety of configurations are contemplated and are possible for inductor 20 and capacitor 35.

In the embodiment shown, inductor 20 and capacitor 35 (if used) are external to IC 75. Thus, inductor 20 and capacitor 35 are coupled to voltage converter 80 using coupling mechanisms of IC 75, such as pads, bondwires, ball grid array, etc., as persons of ordinary skill in the art will understand.

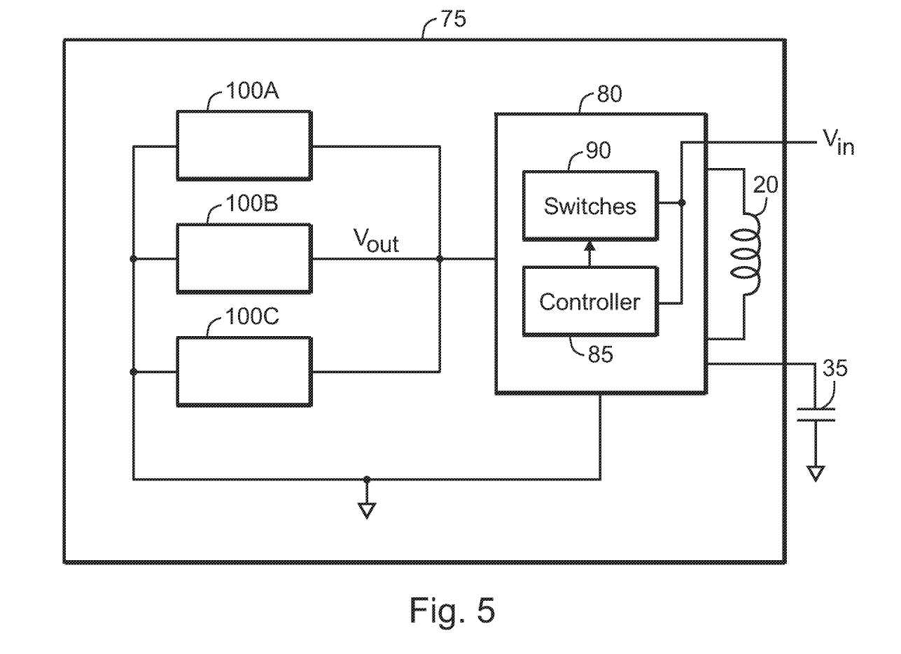

FIG. 5 shows a circuit arrangement for an IC 75 that includes voltage converter 80 according to another exemplary embodiment. IC 75 is similar to the IC depicted in FIG. 4, described above, except that inductor 20 is realized using resources of IC 75, i.e., it resides within IC 75 (e.g., the semiconductor die) or the packaging of IC 75, or both.

More specifically, in some embodiments, inductor 20 may be realized using bondwires, conductor traces, permeable materials, co-packaged discrete component, or a combination of the foregoing, as desired. In other embodiments, inductor 20 may be realized in other ways, as desired. The choice of implementation of inductor 20 depends on a variety of factors, as persons of ordinary skill in the art will understand. Such factors include design specifications, performance specifications, various figures of merit of inductor 20 (e.g., quality factor, or Q, current-handling capability, value of inductance), cost, IC or device area, available technology, such as semiconductor fabrication technology), target markets, target end-users, etc.

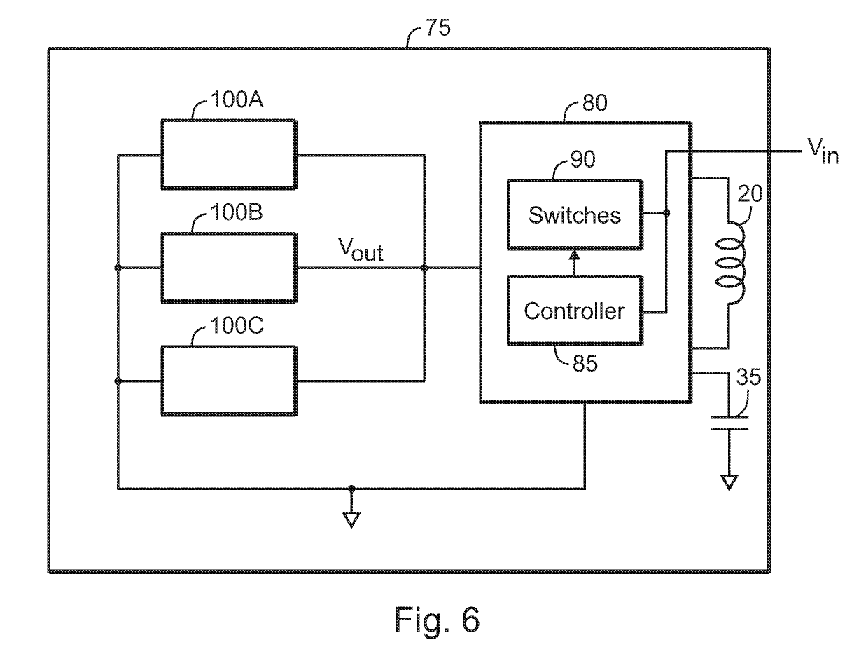

FIG. 6 shows a circuit arrangement for an IC 75 that includes voltage converter 80 according to another exemplary embodiment. IC 75 is similar to the IC depicted in FIG. 4, described above, except that inductor 20 and capacitor 35 are realized using resources of IC 75, i.e., they reside within IC 75 (e.g., the semiconductor die) or the packaging of IC 75, or both.

More specifically, in some embodiments, inductor 20 and capacitor 35 (if used) may be realized using bondwires, conductor traces, metal or other conductor planes, dielectric or permeable materials, co-packaged discrete components, or a combination of the foregoing. In other embodiments, inductor 20 and capacitor 35 may be realized in other ways, as desired. The choice of implementation of inductor 20 and capacitor 35 depends on a variety of factors, as persons of ordinary skill in the art will understand. Such factors include design specifications, performance specifications, various figures of merit of inductor 20 (e.g., Q, current-handling capability, value of inductance), various figures of merit of capacitor 35 (e.g., Q, voltage-handling capability, value of capacitance), cost, IC or device area, available technology, such as semiconductor fabrication technology), target markets, target end-users, etc.

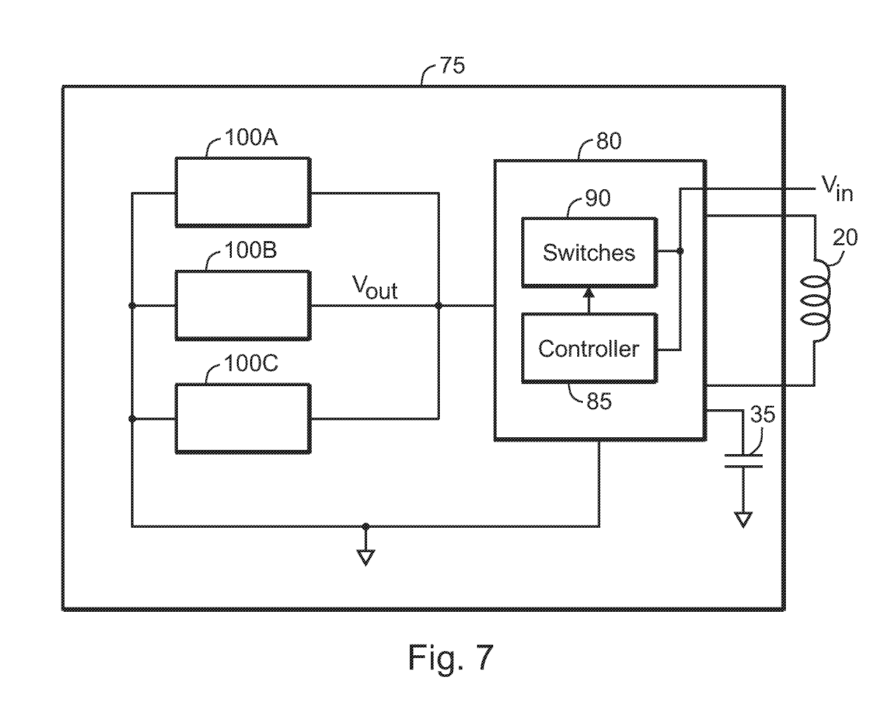

FIG. 7 shows a circuit arrangement for an IC 75 that includes voltage converter 80 according to another exemplary embodiment. IC 75 is similar to the IC depicted in FIG. 4, described above, except that capacitor 35 is realized using resources of IC 75, i.e., it resides within IC 75 (e.g., the semiconductor die) or the packaging of IC 75, or both.

More specifically, in some embodiments, capacitor 35 (if used) may be realized using conductor traces, metal or other conductor planes, dielectric or permeable materials, co-packaged discrete component, or a combination of the foregoing. In other embodiments, capacitor 35 may be realized in other ways, as desired. The choice of implementation of capacitor 35 depends on a variety of factors, as persons of ordinary skill in the art will understand. Such factors include design specifications, performance specifications, various figures of merit of capacitor 35 (e.g., Q, voltage-handling capability, value of capacitance), cost, IC or device area, available technology, such as semiconductor fabrication technology), target markets, target end-users, etc.

Referring to FIGS. 4-7, in some embodiments, one or more of loads 100A-100C may be external to IC 75. In some embodiments, controller 85 resides within IC 75 and, in cooperation with switches 90, inductor 20, and capacitor 35, some of which may be external to IC 75, provides an output voltage to one or more loads external to IC 75. In some embodiments, a controller IC may be used, i.e., controller 85 resides within IC 75, but switches 90, inductor 20, capacitor 35, and loads 100A-100C are external to IC 75.

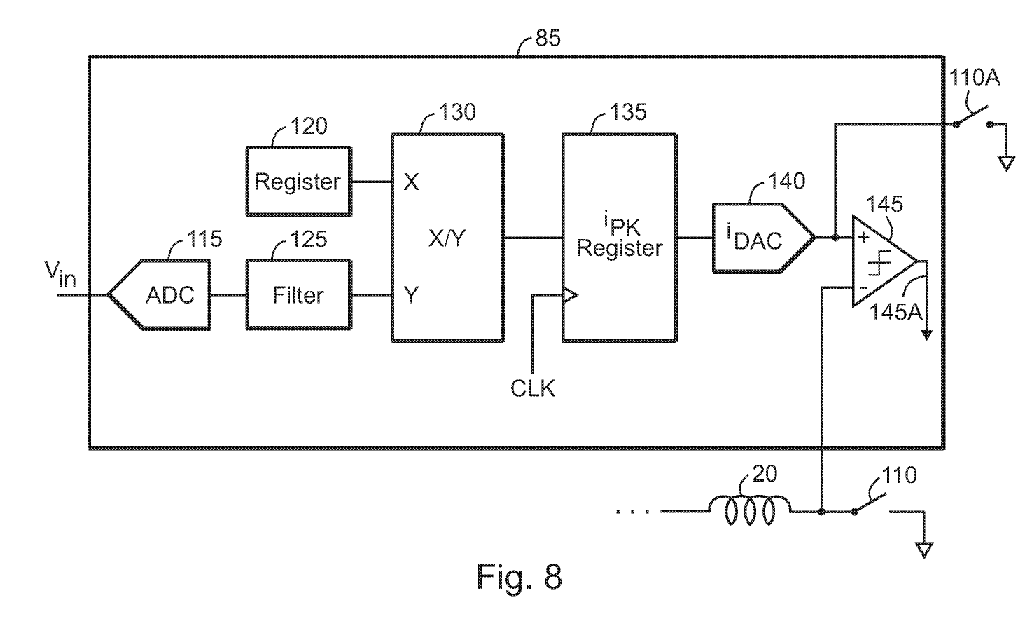

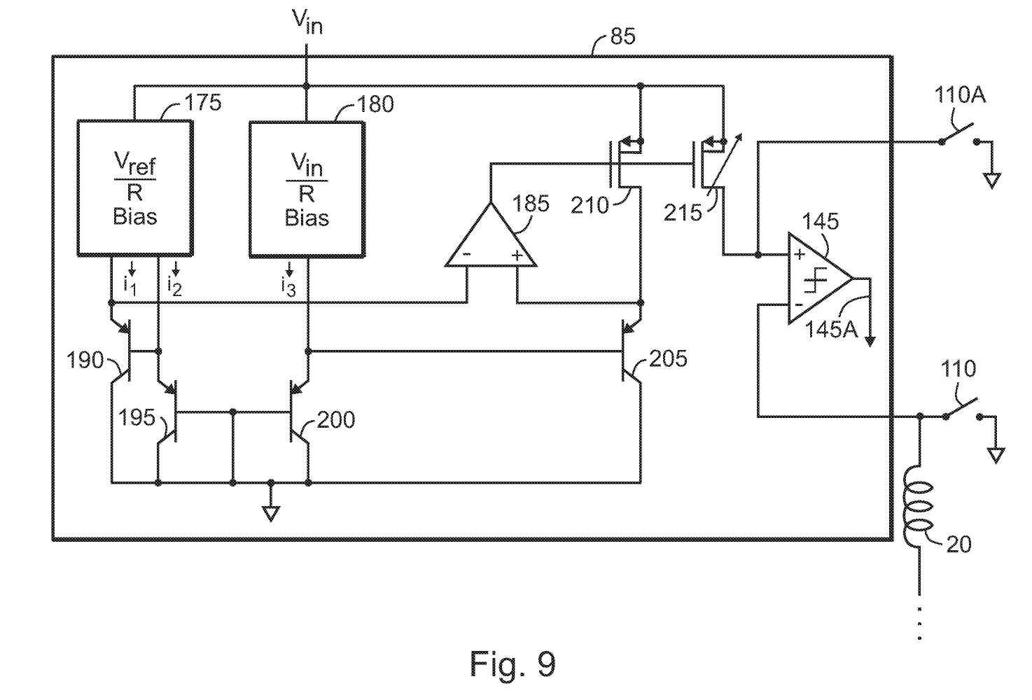

One aspect of the disclosure relates to the implementation of controller 85. Generally speaking, a variety of ways of implementing controller 85 are possible and are contemplated, as persons of ordinary skill in the art will understand. Without limitation, FIGS. 8-9 provide some examples.

FIG. 8 a circuit arrangement including a controller 85 for a voltage converter according to an exemplary embodiment. In the embodiment shown, controller 85 is implemented using mostly digital circuitry (or mixed-signal circuitry). As persons of ordinary skill in the art will understand, however, the circuit arrangement shown is merely exemplary, and other ways of implementing controller 85 are possible and are contemplated.

Referring again to FIG. 8, the input voltage Vᵢₙ is provided to analog-to-digital converter (ADC) 115. ADC 115 converts the input voltage to a digital value, and provides the digital value to filter 125. Filter 125 provides the filtered representation of the input voltage to divider 130.

Register 120 holds a representation of the expected output voltage Vₒᵤₜ multiplied by the desired maximum load current, I_{loadmax}. Because both Vₒᵤₜ and I_{loadmax} are known prior to the operation of controller 85, in some embodiments, register 120 may be loaded based on, for example, information stored in an OTP (one time programmable) memory programmed during manufacture test, or loaded from an external device (e.g., micro-controller unit (MCU)) prior to the enabling or operation of controller 85. Generally, calculating the product to load into register 120 in hardware or software on the IC containing controller 85 would be inefficient.

Divider 130 divides the value at its “X” input by the value at its “Y” input. Thus, divider 130 divides the product of the output voltage and the peak inductor-current by the input voltage, and provides the result to register 135. Register 135, termed the “i_{PK} register,” holds the output value of divider 130, a digital representation of the desired value of the peak inductor-current.

Current-mode digital-to-analog converter (DAC) 140 converts the value held in register 135 to an analog signal, and provides the analog signal to the non-inverting input of comparator 145. The voltage at a node between inductor 20 and one of the switches in the voltage converter, e.g., one of the switches in FIGS. 2-3, labeled generally as switch 110, drives the inverting input of comparator 145.

A switch 110A, which is a replica of switch 110, couples the non-inverting input of comparator 145 to ground during those periods that switch 110 is on, i.e., conducting. In other words, switch 110A is driven by the same control signal that drives switch 110. Output 145A of comparator 145 provides an indication whether the actual value of the peak inductor-current has reached the desired value of the peak inductor-current. The signal at output 145A of comparator 145 is used to drive the switches in the voltage converter (see FIGS. 2-3 for a depiction of the switches in the general voltage converter circuit). Note that the particular arrangement of DAC 140, comparator 145, switch 110, and switch 110A illustrate merely one scheme for using a digital representation of the desired peak current to provide an indication that the peak current has been reached. Other ways of implementing the functionality are contemplated and are possible, as persons of ordinary skill in the art will understand.

In various embodiments, the periodicity of the operation of ADC 115 and filter 125 may be fixed or may be based on dividing the pulse rate of the voltage converter. In some applications, the load current is near zero (or relatively small) at a relatively high duty-cycle, such that actual operation of the voltage converter to provide load current occurs at a relatively low duty-cycle (i.e., the load draws (most) of its current periodically, rather than continuously).

By basing the periodicity of the operation of ADC 115 and filter 125 on a divided pulse rate, most of the operations of ADC 115 occur during the relatively high load current periods. Given the typically non-zero internal resistance or impedance of the source providing the input voltage Vᵢₙ, this arrangement of the operation of ADC 115 and filter 125 allows the capture of the value of the input voltage when the load current is relatively high (when the input voltage has been reduced because of the current drawn). In other words, a more typical value of the input voltage is used when the load actively draws current from the output of the voltage converter.

Note that some of the circuitry in controller 85, such as ADC 115, is not used all of the time, and can therefore be shared with other circuitry present, such as when converter 80 is implemented on an IC (see, for example, FIGS. 4-7 and 10). The sharing of the circuitry might allow for a smaller chip area, and lower cost.

FIG. 9 shows a circuit arrangement including a controller 85 for a voltage converter according to another exemplary embodiment. In the embodiment shown, controller 85 is implemented using mostly analog circuitry. As persons of ordinary skill in the art will understand, however, the circuit arrangement shown is merely exemplary, and other ways of implementing controller 85 are possible and are contemplated.

Controller 85 includes two bias current-sources: V_{ref}/R (labeled 175), where V_{ref} denotes a reference voltage and R denotes a resistance value, and Vᵢₙ/R (labeled 180). Bias current-source 175 provides currents i₁ and i₂ as output signals, which are currents produced based on respective voltages dropped across corresponding resistors. Bias current-source 180 provides current i₃ as an output signal.

Controller 85 includes a current-domain multiplier that includes BJT 190, BJT 195, BJT 200, and BJT 205. The operation of the current-domain multiplier is understood by persons of ordinary skill in the art. The output of the current-domain multiplier is given by:

$${i}_{M 210} = \frac{{i}_{1} \cdot {i}_{2}}{{i}_{3}} ,$$

which is provided to the inverting input of operational amplifier (op-amp) 185. The emitter voltage of BJT 205 drives the non-inverting input of op-amp 185.

The output of op-amp 185 drives the gate of MOSFET 210. Assuming negligible input current of op-amp 185, the current flowing in MOSFET 210 is the same as the emitter current of BJT 205. By virtue of the negative-feedback loop around op-amp 185, op-amp 185 drives the gate of MOSFET 210 such that the output current generated by MOSFET 210 is

$${i}_{out} ∝ \frac{{V}_{ref}^{2}}{{RV}_{in}} .$$

In other words, the output current is proportional to the inverse of the input voltage Vᵢₙ.

MOSFET 215 mirrors the current flowing in MOSFET 210, using an adjustable scaling factor. More specifically, the current in MOSFET 215 is an adjustable scaled version of the current flowing in MOSFET 210. Thus, MOSFET 215 allows programming i_{PK} times Vₒᵤₜ. Overall, the output current in MOSFET 215 is a function of, or is derived from, the input voltage Vᵢₙ. The adjustable scaling factor may be implemented in a number of ways, for example, by varying the effective width-to-length ratio (W/L) of MOSFET 215 (e.g., by using a set of smaller MOSFETs coupled in parallel and driving selected MOSFETs in the set of MOSFETs to achieve a desired W/L ratio).

The circuit arrangement in FIG. 9 further includes comparator 145, switch 110, replica switch 110A, and inductor 20. Those components operate similarly, and perform similar functions as the counterpart components in FIG. 8, described above.

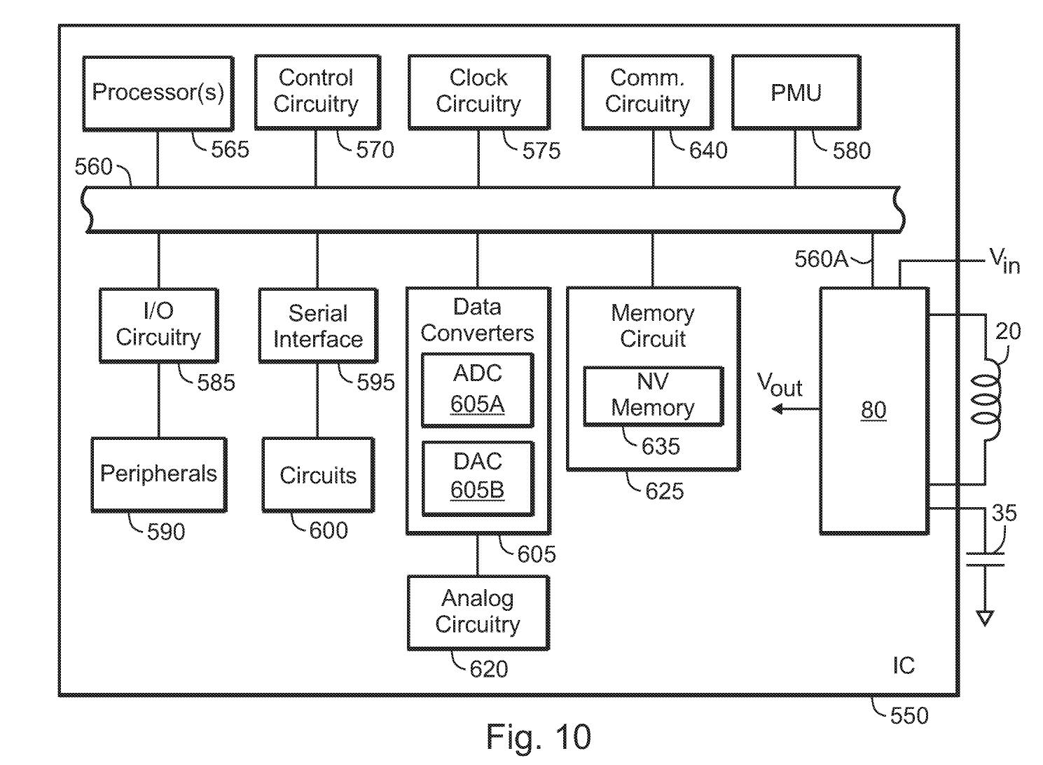

As noted, DC-DC switch-mode converters according to various embodiments may be used in a variety of circuits, blocks, subsystems, and/or systems. For example, in some embodiments, one or more DC-DC switch-mode converters may be integrated in an MCU. FIG. 10 shows a circuit arrangement for such an exemplary embodiment.

MCU 550 includes one or more DC-DC switch-mode converters 80 (as described above). DC-DC switch-mode converter(s) 80 provides power to one or more blocks or circuits or subsystems in MCU 550. In some embodiments, DC-DC switch-mode converter(s) 80 may instead or in addition provide power to one or more circuits, systems, blocks, subsystems, etc., that are external to MCU 550, for instance, by using one or more package pins or pads of MCU 550.

MCU 550 includes a number of blocks (e.g., processor(s) 565, data converter 605, I/O circuitry 585, etc.) that communicate with one another using a link 560. In exemplary embodiments, link 560 may constitute a coupling mechanism, such as a bus, a set of conductors or semiconductor elements (e.g., traces, devices, etc.) for communicating information, such as data, commands, status information, and the like.

MCU 550 may include link 560 coupled to one or more processors 565, clock circuitry 575, and power management circuitry or power management unit (PMU) 580. In some embodiments, processor(s) 565 may include circuitry or blocks for providing information processing (or data processing or computing) functions, such as central-processing units (CPUs), arithmetic-logic units (ALUs), and the like. In some embodiments, in addition, or as an alternative, processor(s) 565 may include one or more DSPs. The DSPs may provide a variety of signal processing functions, such as arithmetic functions, filtering, delay blocks, and the like, as desired.

Clock circuitry 575 may generate one or more clock signals that facilitate or control the timing of operations of one or more blocks in MCU 550. Clock circuitry 575 may also control the timing of operations that use link 560, as desired. In some embodiments, clock circuitry 575 may provide one or more clock signals via link 560 to other blocks in MCU 550.

In some embodiments, PMU 580 may reduce an apparatus's (e.g., MCU 550) clock speed, turn off the clock, reduce power, turn off power, disable (or power down or place in a lower power consumption or sleep or inactive or idle state), enable (or power up or place in a higher power consumption or normal or active state) or any combination of the foregoing with respect to part of a circuit or all components of a circuit, such as one or more blocks in MCU 550. Further, PMU 580 may turn on a clock, increase a clock rate, turn on power, increase power, or any combination of the foregoing in response to a transition from an inactive state to an active state (including, without limitation, when processor(s) 565 make a transition from a low-power or idle or sleep state to a normal operating state).

In addition, in some embodiments, PMU 580 may include control functionality and/or circuitry to control converter 80. In some embodiments, PMU 580 may include some of the control functionality and/or circuitry used to control converter 80. In some embodiments, converter 80 may include control functionality and/or circuitry to control converter 80. Similar considerations apply to control circuitry 570 (e.g., control circuitry 570 may include some or all of the control functionality and/or circuitry to control converter 80, etc.). In some embodiments, one or more blocks or circuits in MCU 550, such as ADC 605A and DAC 605B, may be used as part of controller 85 (not shown explicitly) to control converter 80, for example, when an implementation of controller 85 as shown in FIG. 8 is used.

Referring again to FIG. 10, link 560 may couple to one or more circuits 600 through serial interface 595. Through serial interface 595, one or more circuits or blocks coupled to link 560 may communicate with circuits 600, which may reside outside IC 550. Circuits 600 may communicate using one or more serial protocols, e.g., SMBUS, I²C, SPI, and the like, as person of ordinary skill in the art will understand.

Link 560 may couple to one or more peripherals 590 through I/O circuitry 585. Through I/O circuitry 585, one or more peripherals 590 may couple to link 560 and may therefore communicate with one or more blocks coupled to link 560, e.g., processor(s) 565, memory circuit 625, etc.

In exemplary embodiments, peripherals 590 may include a variety of circuitry, blocks, and the like. Examples include I/O devices (keypads, keyboards, speakers, display devices, storage devices, timers, sensors, etc.). Note that in some embodiments, some peripherals 590 may be external to MCU 550. Examples include keypads, speakers, and the like.

In some embodiments, with respect to some peripherals, I/O circuitry 585 may be bypassed. In such embodiments, some peripherals 590 may couple to and communicate with link 560 without using I/O circuitry 585. In some embodiments, such peripherals may be external to MCU 550, as described above.

Link 560 may couple to analog circuitry 620 via data converter(s) 605. Data converter(s) 605 may include one or more ADCs 605A and/or one or more DACs 605B.

ADC(s) 605A receive analog signal(s) from analog circuitry 620, and convert the analog signal(s) to a digital format, which they communicate to one or more blocks coupled to link 560. Conversely, DAC(s) 605B receive digital signal(s) from one or more blocks coupled to link 560, and convert the digital signal(s) to analog format, which they communicate to analog circuitry 620.

Analog circuitry 620 may include a wide variety of circuitry that provides and/or receives analog signals. Examples include sensors, transducers, and the like, as person of ordinary skill in the art will understand. In some embodiments, analog circuitry 620 may communicate with circuitry external to MCU 550 to form more complex systems, sub-systems, control blocks or systems, feedback systems, and information processing blocks, as desired.

Control circuitry 570 couples to link 560. Thus, control circuitry 570 may communicate with and/or control the operation of various blocks coupled to link 560 by providing control information or signals. In some embodiments, control circuitry 570 also receives status information or signals from various blocks coupled to link 560. In addition, in some embodiments, control circuitry 570 facilitates (or controls or supervises) communication or cooperation between various blocks coupled to link 560.

In some embodiments, control circuitry 570 may initiate or respond to a reset operation or signal. The reset operation may cause a reset of one or more blocks coupled to link 560, of MCU 550, etc., as person of ordinary skill in the art will understand. For example, control circuitry 570 may cause PMU 580, and circuitry such as DC-DC switch-mode converter(s) 80, to assume a known state (e.g., providing one or more voltages having desired values).

In exemplary embodiments, control circuitry 570 may include a variety of types and blocks of circuitry. In some embodiments, control circuitry 570 may include logic circuitry, finite-state machines (FSMs), or other circuitry to perform operations such as the operations described above.

Communication circuitry 640 couples to link 560 and also to circuitry or blocks (not shown) external to MCU 550. Through communication circuitry 640, various blocks coupled to link 560 (or MCU 550, generally) can communicate with the external circuitry or blocks (not shown) via one or more communication protocols. Examples of communications include USB, Ethernet, and the like. In exemplary embodiments, other communication protocols may be used, depending on factors such as design or performance specifications for a given application, as person of ordinary skill in the art will understand.

As noted, memory circuit 625 couples to link 560. Consequently, memory circuit 625 may communicate with one or more blocks coupled to link 560, such as processor(s) 565, control circuitry 570, I/O circuitry 585, etc.

Memory circuit 625 provides storage for various information or data in MCU 550, such as operands, flags, data, instructions, and the like, as persons of ordinary skill in the art will understand. Memory circuit 625 may support various protocols, such as double data rate (DDR), DDR2, DDR3, DDR4, and the like, as desired.

In some embodiments, memory read and/or write operations by memory circuit 625 involve the use of one or more blocks in MCU 550, such as processor(s) 565. A direct memory access (DMA) arrangement (not shown) allows increased performance of memory operations in some situations. More specifically, DMA (not shown) provides a mechanism for performing memory read and write operations directly between the source or destination of the data and memory circuit 625, rather than through blocks such as processor(s) 565.

Memory circuit 625 may include a variety of memory circuits or blocks. In the embodiment shown, memory circuit 625 includes non-volatile (NV) memory 635. In addition, or instead, memory circuit 625 may include volatile memory (not shown), such as random access memory (RAM). NV memory 635 may be used for storing information related to performance, control, or configuration of one or more blocks in MCU 550. For example, NV memory 635 may store configuration information related to DC-DC switch-mode converter(s) 80.

Note that in the exemplary embodiment shown, inductor 20 and capacitor 35 (if used) are external to MCU 550 (similar to the arrangement shown in FIG. 4). Other embodiments are possible and are contemplated, as persons of ordinary skill in the art will understand. Examples include MCUs where one or both of inductor 20 and capacitor 35 are realized using resources of MCU 550, as described above in connection with FIGS. 5-7.

Various circuits and blocks described above and used in exemplary embodiments may be implemented in a variety of ways and using a variety of circuit elements or blocks. For example, various switches (25, 30, 40, 45, 48, 51, 110, and 110A), controller 85, ADC 115, filter 125, register 120, divider 130, register 135, DAC 140, comparator 145, bias current-source 175, bias current-source 180, op-amp 185, and various blocks in MCU 550 (see FIG. 10) may generally be implemented using digital circuitry, analog circuitry, or mixed-signal circuitry (a mix of digital and analog circuitry). The digital circuitry may include circuit elements or blocks such as gates, digital multiplexers (MUXs), latches, flip-flops, registers, finite state machines (FSMs), processors, programmable logic (e.g., field programmable gate arrays (FPGAs) or other types of programmable logic), arithmetic-logic units (ALUs), standard cells, custom cells, etc., as desired, and as persons of ordinary skill in the art will understand. In addition, analog circuitry or mixed-signal circuitry or both may be included, for instance, power converters, discrete devices (transistors, capacitors, resistors, inductors, diodes, etc.), and the like, as desired. The analog circuitry may include bias circuits, decoupling circuits, coupling circuits, supply circuits, current mirrors, current and/or voltage sources, filters, amplifiers, converters, signal processing circuits (e.g., multipliers), detectors, transducers, discrete components (transistors, diodes, resistors, capacitors, inductors), analog MUXs and the like, as desired, and as persons of ordinary skill in the art will understand. The choice of circuitry for a given implementation depends on a variety of factors, as persons of ordinary skill in the art will understand. Such factors include design specifications, performance specifications, cost, IC or device area, available technology, such as semiconductor fabrication technology), target markets, target end-users, etc.

Referring to the figures, persons of ordinary skill in the art will note that the various blocks shown might depict mainly the conceptual functions and signal flow. The actual circuit implementation might or might not contain separately identifiable hardware for the various functional blocks and might or might not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation. Other modifications and alternative embodiments in addition to the embodiments in the disclosure will be apparent to persons of ordinary skill in the art. Accordingly, the disclosure teaches those skilled in the art the manner of carrying out the disclosed concepts according to exemplary embodiments, and is to be construed as illustrative only. Where applicable, the figures might or might not be drawn to scale, as persons of ordinary skill in the art will understand.

The particular forms and embodiments shown and described constitute merely exemplary embodiments. Persons skilled in the art may make various changes in the shape, size and arrangement of parts without departing from the scope of the disclosure. For example, persons skilled in the art may substitute equivalent elements for the elements illustrated and described. Moreover, persons skilled in the art may use certain features of the disclosed concepts independently of the use of other features, without departing from the scope of the disclosure.

1. An apparatus, comprising:
a voltage converter to convert an input voltage to an output voltage, the voltage converter comprising:
an inductor; and
a controller to control a current flowing through the inductor using a peak inductor-current derived from the input voltage of the voltage converter.

2. The apparatus according to claim 1, wherein the controller controls a set of switches in the voltage converter to control the current flowing through the inductor.

3. The apparatus according to claim 2, wherein the controller controls the set of switches in the voltage converter using pulse-frequency modulation (PFM).

4. The apparatus according to claim 3, wherein the controller controls the current flowing through the inductor by charging the inductor to the peak inductor-current during each PFM pulse.

5. The apparatus according to claim 1, wherein the peak inductor-current derived from the input voltage of the voltage converter comprises an inverse of the input voltage of the voltage converter.

6. The apparatus according to claim 1, wherein the voltage converter comprises a boost voltage converter.

7. The apparatus according to claim 1, wherein the voltage converter comprises a buck-boost voltage converter.

8. The apparatus according to claim 1, wherein the controller comprises:
an analog-to-digital converter (ADC) to convert the input voltage of the voltage converter to a first digital value;
a divider to divide a digital value by a filtered version of the first digital value;
a digital-to-analog (DAC) converter to convert an output of the divider to an analog signal; and
a comparator coupled to receive the analog signal and to indicate when the current flowing through the inductor has reached the peak inductor-current.

9. The apparatus according to claim 1, wherein the controller comprises:
a pair of bias current-sources to provide a set of current signals;
a current-domain multiplier to derive an output value from the set of current signals;
an operational amplifier coupled in a feedback loop to provide an output signal derived an output value of the current-domain multiplier; and
a comparator coupled to receive the output signal of the operational amplifier and to indicate when the current flowing through the inductor has reached a pre-selected multiple of the current at the output of the current domain multiplier.

10. An integrated circuit (IC), comprising:
a voltage converter operating in a boost mode to convert an input voltage to an output voltage that is higher than the input voltage, the voltage converter comprising:
an inductor coupled to a set of switches; and
a controller to control the set of switches using pulse-frequency modulation (PFM) such that a peak inductor-current substantially equals a value derived from the input voltage of the voltage converter.

11. The IC according to claim 10, wherein the inductor is charged to the value derived from the input voltage of the voltage converter during each PFM pulse.

12. The IC according to claim 10, wherein the value derived from the input voltage of the voltage converter equals an inverse of the input voltage of the voltage converter.

13. The IC according to claim 10, wherein the voltage converter comprises a boost converter or a buck-boost converter.

14. The IC according to claim 10, wherein the IC comprises a microcontroller unit (MCU).

15. A method of operating a voltage converter, the method comprising:
deriving a peak-current value from an input voltage of the voltage converter; and
controlling a set of switches in the voltage converter to repetitively charge an inductor in the voltage converter to the derived peak-current value.

16. The method according to claim 15, wherein controlling the set of switches in the voltage converter comprises using pulse-frequency modulation (PFM).

17. The method according to claim 16, wherein controlling the set of switches in the voltage converter to repetitively charge the inductor in the voltage converter to the derived peak-current value comprises charging the inductor to the peak inductor-current during each PFM pulse.

18. The method according to claim 15, wherein the derived peak-current value comprises an inverse of the input voltage of the voltage converter.

19. The method according to claim 15, wherein the voltage converter operates in a boost mode.

20. The method according to claim 15, wherein the voltage converter comprises a boost converter or a buck-boost converter.
